(19) United States
(12) Patent Application Publication
(10) Pub. No.: US 2014/0105069 A1
(43) Pub. Date: Apr. 17, 2014

(54) Mobile Network Management Using Multiple Wireless Modems

(71) Applicant: Santosh Kumar Potnuru, Slough (GB)

(72) Inventor: Santosh Kumar Potnuru, Slough (GB)

(73) Assignee: Smith Micro Software., Inc., Aliso Viejo, CA (US)

(21) Appl. No.: 13/654,311

(22) Filed: Oct. 17, 2012

(51) Int. Cl. H04W 48/18

(52) U.S. Cl. 370/255

(57) ABSTRACT

Presented is a system and method for providing mobile network management using multiple wireless modems. The method includes receiving a plurality of parameters relating to a plurality of wireless networks using a plurality of wireless modems each operable for communication according to one of the plurality of wireless networks. The method further includes evaluating the plurality of parameters according to one or more connection rules. Based on the evaluating, a connection is established to a first wireless network of the plurality of wireless networks using a first wireless modem of the plurality of wireless modems operable for communication according to the first wireless network.

### BACKGROUND

Conventional wireless devices are typically capable of connecting to networks serviced by a single network carrier. However, being restricted to a single network limits the coverage, quality of service, cost, and feature set available to the end user. For example, a wireless device serviced by a particular network carrier is typically required to connect to the carrier's associated network unless the network is currently unavailable. Consequently, the end user is limited to the coverage area, upload and download speeds, network features and services, and associated prices offered by the single network carrier. If the conventional wireless device loses the available connection, or the end user wants to switch to a different network carrier's available network, the end user has been required to reconnect using another device, or to replace the wireless device's SIM (SIM/USIM/CMSIM) card to one associated with the different network carrier. Because the end user cannot know the quality of the connection to the different network before SIM card replacement and reconnection, quality of service (QoS) is based on trial and error. This manual process can be tedious. In addition, though a particular network may provide better features, prices, data speeds, or QoS at a particular time and/or location, the end user has no way of automatically determining which network is currently most desirable. Thus, end users have been required to accept a suboptimal user experience.

### SUMMARY OF THE INVENTION

The present disclosure is directed to mobile network management using multiple wireless modems, substantially as shown in and/or described in connection with at least one of the figures, and as set forth more completely in the claims.

### BRIEF DESCRIPTION OF THE DRAWINGS

FIG. 1 presents an exemplary system for providing mobile network management using multiple wireless modems, according to one implementation of the present application;

FIG. 2 presents an exemplary connectivity application core for providing mobile network management using multiple wireless modems, according to an implementation of the present application;

FIG. 3 presents an exemplary rules engine including several rules for mobile network management using multiple wireless moderns, according to one implementation of the present application;

FIG. 4 presents an exemplary flowchart illustrating a method for providing mobile network management using multiple wireless modems, according to one implementation of the present application; and

FIG. 5 presents another exemplary flowchart illustrating a method for providing mobile network management using multiple wireless modems, according to one implementation of the present application.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

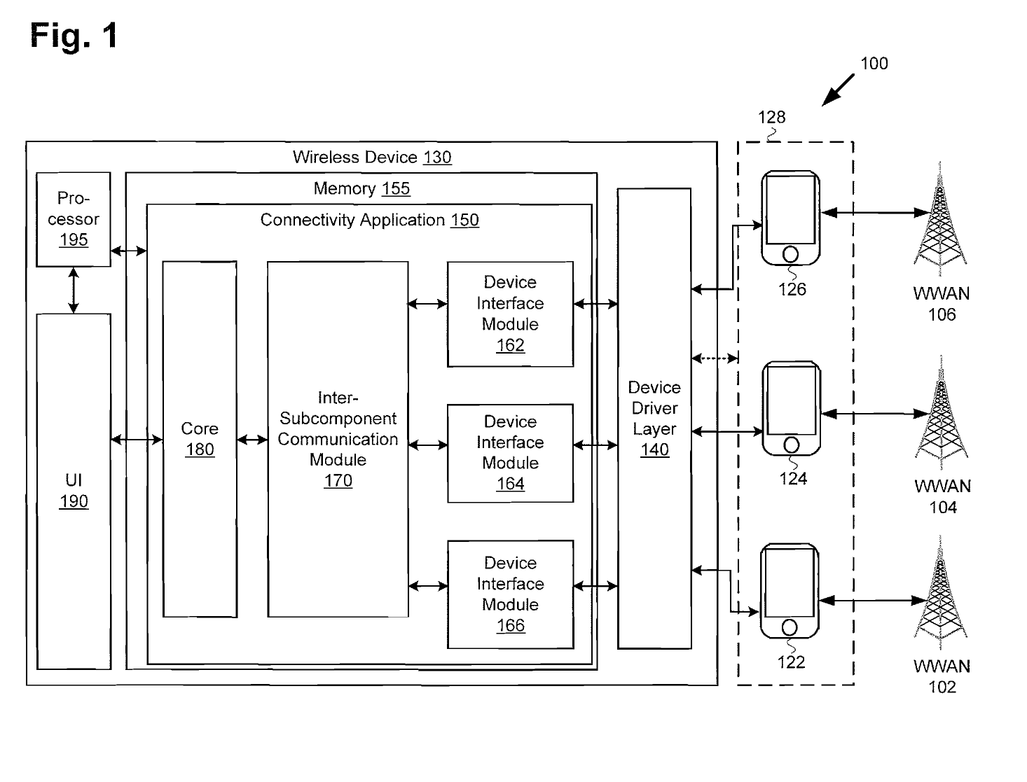

The present application presents a solution that utilizes a wireless device connected to multiple wireless moderns, each associated with a different mobile network carrier, to automatically detect available WWAN networks corresponding to each of the wireless modems. One or more of the available networks may be selected by the wireless device and the wireless device may be connected to the selected network using the associated wireless modem. Selection from the available networks may be based on real-time conditions of the networks and/or the wireless device as well as user-controlled and carrier-controlled policies utilizing an intelligent rules engine embedded within the wireless device. Thus, the wireless device may automatically and seamlessly provide the best network coverage, data rates, network service features and/or lowest cost based on a pre-defined set of connection rules or manual end user network selection. In addition, the present application provides this solution without requiring new device hardware, firmware, drivers, or device APIs for existing legacy equipment. For the purpose of this application, the term “wireless device” may relate to any electronic device which is configured to communicate with one or more other electronic devices directly over wireless communication channels, or indirectly over wireless communication channels by way of a wired connection to one or more electronic devices which may in turn enable communication over wireless communication channels. Non-limiting examples of such “wireless devices” may include a PC, smart phone, PDA, laptop or PC tablet. FIG. 1 presents an exemplary system for providing mobile network management using multiple wireless modems, according to one implementation of the present application. As shown in FIG. 1, system 100 may include wireless device 130 connected to several wireless moderns, for example, wireless modem 122, wireless modem 124, and wireless modem 126. Each of the wireless modems may be part of a separate mobile device, for example, a smartphone, a PDA, a laptop, a tablet PC, or any other mobile device capable of wireless communication. In one alternative, each of the wireless moderns may be a part of wireless device 130 itself, each configured through the use of a different SIM card programmed for use on either the same wireless network or on a different wireless network. In another alternative, each of the wireless modems may be contained in a single combination modern. In such an alternative implementation, each of wireless modems 122, 124 and 126 may be contained within combination modern 128. The outline of combination modem 128 is shown as a dotted line to signify that wireless moderns 122, 124 and 126 may be contained in the combination modern if present in system 100. System 100 may further include several wireless networks, such as WWAN 102, WWAN 104 and WWAN 106, over which each of wireless modems 122, 124, 126 may connect for sending and/or receiving desired content. Each of WWANs 122, 124, 126 may be one of a 2G network, a 3G network, a 4G network, an LTE network, or any other wireless network without limitation. Additionally, each of WWANs 122, 124, 126 may be serviced by a different wireless carrier. However, the present application is not limited in this manner, and two or more of WWANs 122, 124, 126 may be serviced by the same wireless carrier. Wireless device 130 may potentially connect to one or more of WWAN networks 102, 104, 106 through a respective one of wireless modems 122, 124, 126 depending on which connection or connections is/are most desirable for a particular wireless device state and/or network-wide state.

Wireless device 130 may include device driver layer 140, memory 155 including connectivity application 150, user interface (UI) 190 and processor 195. Connectivity application 150 may run on wireless device 130, as a software program for example, and may be configured to support multiple wireless modems at the same time. Connectivity application 150 may support each of wireless moderns 122, 124, 126 through a respective one of device interface modules 162, 164 and 166. For example, each of device interface modules 162, 164, 166 is configured to communicate with and control a respective one of wireless modems 122, 124, 126 using a corresponding device driver installed in device driver layer 140. Where combination modem 128 is present in system 100, one of device interface modules 162, 164, and 166 may be configured to communicate with combination modem 128. In the alternative, each of device interface modules 162, 164 and 166 may be configured to communicate with a respective one of wireless modems 122, 124 and 126 within combination modem 128. Inter-Subcomponent communication module 170 is configured to provide communication between device interface modules as well as between each device interface module and core 180. For example, one or more parameters relating to each of WWANs 102, 104, 106 may be transmitted from the respective wireless modem, through device driver layer 140 to a respective device interface module. Each of device interface modules 162, 164, 166 forwards the parameters to inter-subcomponent module 170, which forwards the parameters to core 180. Core 180 evaluates the parameters according to one or more user-controlled and/or carrier-controlled rules. Based on this evaluation, core 180 determines which wireless modern to connect to and passes this determination to inter-subcomponent module 170, which requests an operation from the appropriate wireless modern using the associated device interface module.

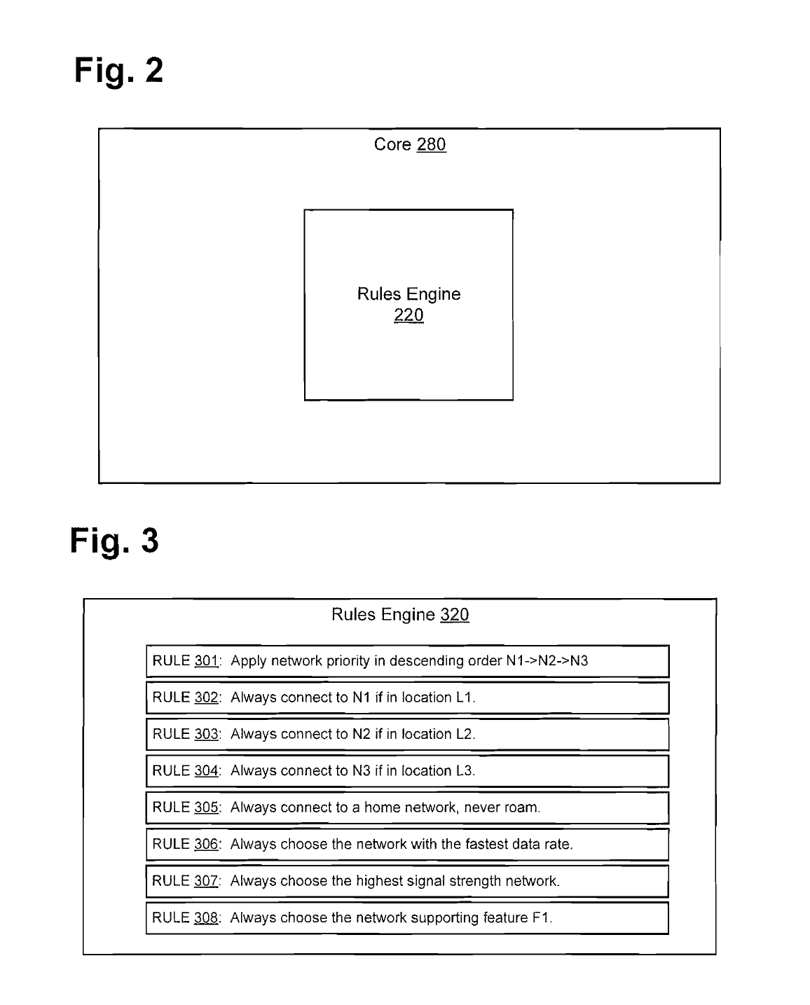

Processor 195 may be configured to perform any calculations within wireless device 130 as necessary, according to one or more implementations of the present application. UI 190 may be configured to capture user actions and/or user preferences, which may be utilized by core 180 in determining the appropriate wireless modem for connection with wireless device 130. A more detailed description of the operation of core 180 is discussed regarding FIG. 2.

FIG. 2 presents an exemplary connectivity application core for providing mobile network management using multiple wireless modems, according to an implementation of the present application. FIG. 2 shows core 280, which may include rules engine 220. One or more rules may be input to rules engine 220, including carrier-controlled rules, and/or user-controlled rules based on the user's requirements or preferences. Thus, the wireless modem connected at a particular time may be changed either by direct user intervention or by automatic application of one or more rules of rules engine 220. Thus, rules engine 220 is responsible for determining which wireless network to connect to in the event the current connection is lost, connection quality is reduced, or new networks become available.

In addition, carrier-controlled rules may be applied to a group of wireless devices based on any number of criteria. Non-limiting examples of such rule-grouping criteria may include grouping based on a wireless device make or model, a particular geographical location, a particular subscriber plan or entitlement, custom created groups of subscribers, or any combination of subscriber information, service type, application type or network type. In this way multiple sets of network connection rules may be developed for different groupings of wireless devices, allowing simultaneous achievement of multiple user-controlled and/or carrier-controlled goals. In addition, the goal or goals for which network connection policies are focused may be modified by the carrier and/or the end user at any time. A more detailed example of rules fed to rules engine 220 is discussed regarding FIG. 3.

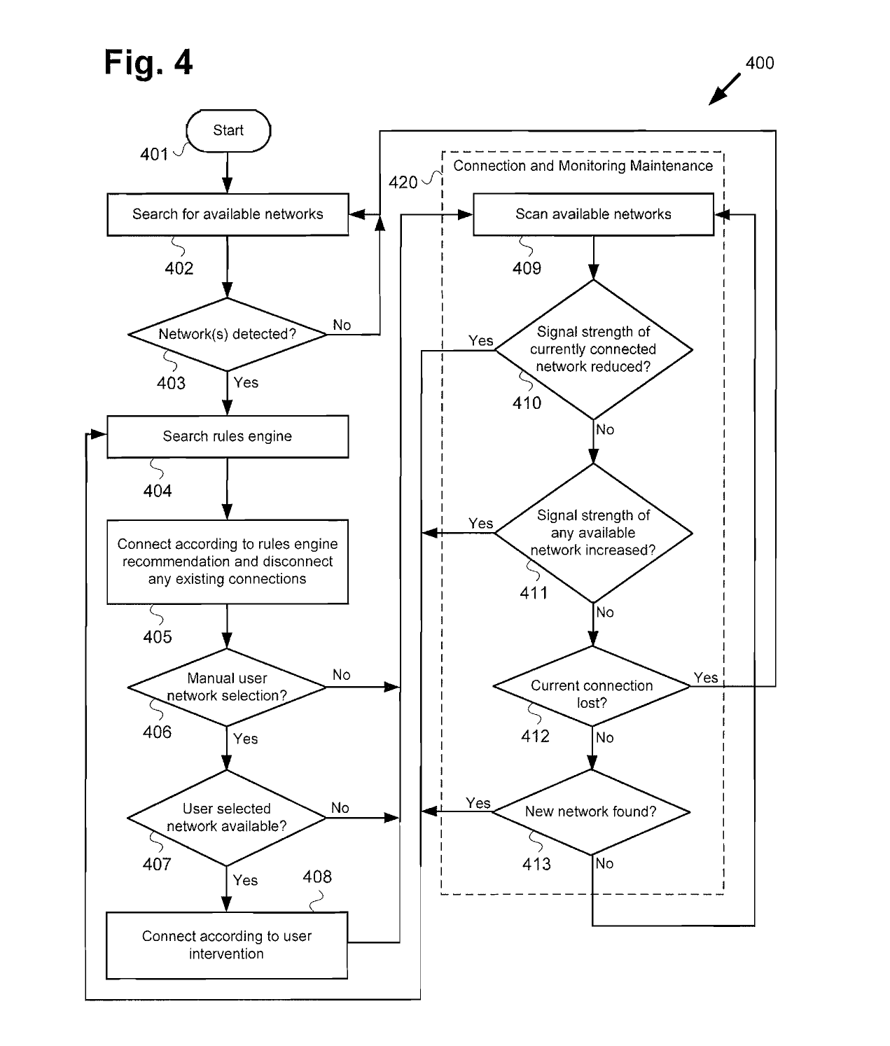

FIG. 3 presents an exemplary rules engine including several policy-based rules for mobile network management using multiple wireless modems, according to one implementation of the present application. For example, FIG. 3 shows rules engine 320 including exemplary rules 301-308. Rules engine 320 may use rules 301-308 in determining which network to connect to according to current network parameters and/or user preferences. N1 may correspond to a first wireless network, for example, WWAN 102 of FIG. 1. N2 may correspond to a second wireless network, for example, WWAN 104 of FIGS. 1. And N3 may correspond to a third wireless network, for example, WWAN 106 of FIG. 1. Likewise, L1, L2 and L3 may correspond to respective first, second and third geographical locations of the wireless device. Finally, F1 may refer to a specific feature, function or service only available on certain networks. Thus, exemplary rule 301 may set an absolute priority for connection to networks N1-N3. Exemplary rules 302-304 may set conditional priorities for connection to specific networks based on a current geographical location of the wireless device. Exemplary rule 305 may set relative priority regarding network connection based on a particular available network's classification as a home or roaming network. Exemplary rules 306-307 may set relative priority for connection to networks based on parameters or characteristics of a particular network, such as data rate and/or signal strength. Finally, exemplary rule 308 may set relative priority for connection to networks based on a particular network supporting a particular feature or function F1. How one or more implementations of the present application carry out policy-based mobile network management using multiple wireless modems may be described in more detail regarding FIG. 4.

FIG. 4 presents an exemplary flowchart illustrating a method for providing mobile network management using multiple wireless modems, according to one implementation of the present application. Flowchart 400 begins at Start 401. The method continues to action 402, which includes searching for available networks. For example, wireless device 130 may prompt each of wireless modems 122, 124 and 126 to transmit parameters regarding the availability of its respective wireless network. At action 403, a determination as to whether any networks are available or detected is made. If a network is not detected, the method may cycle back to action 402 and continue searching for available networks until one is found. If a network is detected the method continues to action 404, which includes searching the rules engine. For example, wireless device 130 may utilize any received parameters relating to the detected network(s) in applying one or more user-controlled and/or carrier-controlled rules, such as one or more of exemplary rules 301-308 of FIG. 3, to determine the most appropriate network for connection to wireless device 130. The method continues to action 405, which includes connecting according to the rules engine recommendation. At this point any existing connections may be disconnected.

At this point, manual selection via the user interface of the wireless device may be taken into account. In such a case, a plurality of parameters relating to the networks may be communicated to a display of wireless device 130, for example, UI 190. A user of wireless device 130 may input a selection of one or more of the associated networks into UI 190. At this point the method continues with action 406, which includes determining if a manual user network selection has been made. If a manual user selection has been made, the method continues to action 407, which includes determining if the user-selected network is available. If the selected network is available, a connection is made according to the user intervention as shown by action 408 and the method continues to connection and monitoring maintenance 420. Likewise, if no manual user network selection was made at action 406, or the user selected network was not available at action 407, the method continues to connection and monitoring maintenance 420.

At this point the method continues with action 409, which includes scanning available networks. Thereafter, action 410 includes determining whether signal strength of the currently connected network has been reduced since selection. If no reduction in signal strength is determined, a second determination as to whether signal strength of any available network has increased since selection is carried out in action 411. If the determination to either of actions 410 or 411 is affirmative, the method cycles back to action 404 where the rules engine is searched and any received parameters relating to detected networks are again applied to one or more rules to determine the most appropriate network for connection.

However, if the determination to both actions 410 and 411 are negative, the method continues to action 412, where it is determined whether the current connection is lost. If so, the method cycles back to action 402 where another search for available networks is carried out. If action 412 results in a determination that the current connection was not lost, the method advances to action 413, which includes a determination as to whether a new network was found. If a new network is found, the method cycles back to action 404, where the rules engine is searched again and any received parameters relating to detected networks are evaluated according to one or more rules to determine the most appropriate network for connection. If the determination at action 413 is negative, the method cycles back to action 409, where a scan for available networks is again made.

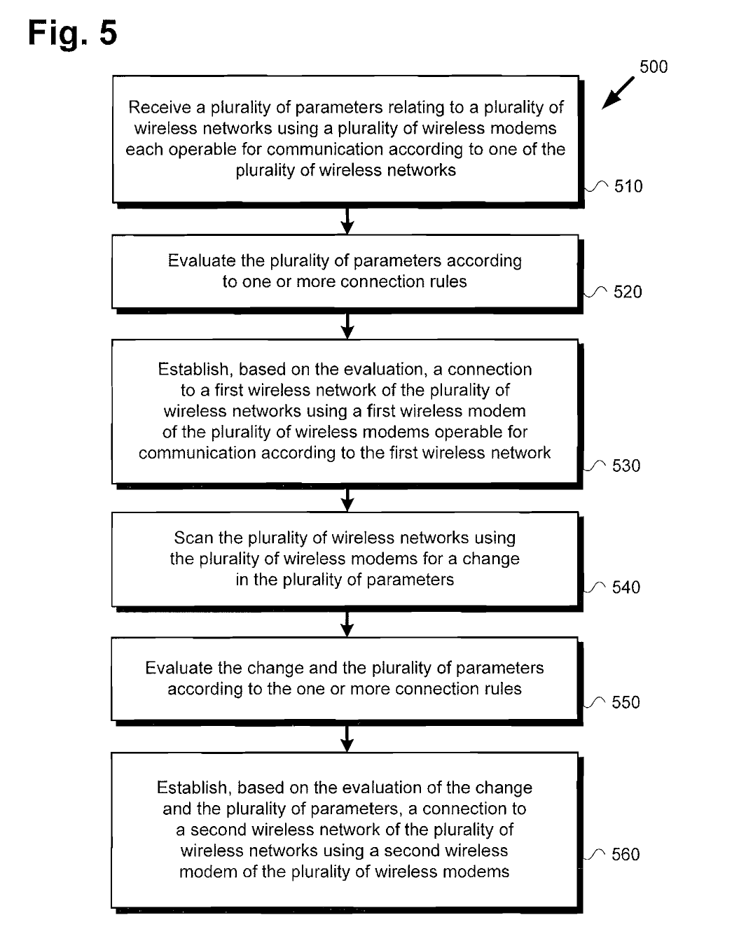

FIG. 5 presents another exemplary flowchart illustrating a method for providing mobile network management using multiple wireless modems, according to one implementation of the present application. Flowchart 500 may be based, at least in part, on the method shown in flowchart 400 of FIG. 4. Action 510 of flowchart 500 includes receiving a plurality of parameters relating to a plurality of wireless networks using a plurality of wireless modems each operable for communication according to one of the plurality of wireless networks. Such parameters may include, as an example and without limitation, a data upload rate, a data download rate, a time of day, a day of the year, a location, a cost of communicating over a particular wireless network, a signal strength associated with the particular wireless network, a carrier identification associated with the particular wireless network, and an availability of a particular network service.

Action 520 of flowchart 500 includes evaluating the plurality of parameters according to the one or more connection rules. For example, rules engine 320 may evaluate the parameters according to one or more rules, such as rules 301-308 of FIG. 3.

Action 530 of flowchart 500 includes establishing, based on the evaluation, a connection to a first wireless network of the plurality of wireless networks using a first wireless modem of the plurality of wireless moderns operable for communication according to the first wireless network. For example, core 180 may direct inter-subcomponent communication module 170 to establish a connection to WWAN 106 using wireless modem 126 through device interface module 162 and the appropriate device driver within device driver layer 140.

Action 540 of flowchart 500 includes scanning the plurality of wireless networks using the plurality of wireless moderns for a change in the plurality of parameters. For example, wireless device 130 may scan the available networks using wireless modems 122, 124, 126 and may directly or indirectly detect changes in a general geographical location of wireless device 130, the strength of one or more available networks, and/or a data rate of the one or more available networks.

Action 550 of flowchart 500 includes evaluating the change and the plurality of parameters according to the one or more connection rules. For example, once a change in one or more parameters has been detected, the change as well as each of the parameters absolute values may be evaluated according to one or more rules, such as rules 301-308, within rules engine 320.

Action 560 of flowchart 500 includes establishing, based on the evaluation of the change and the plurality of parameters, a connection to a second wireless network of the plurality of wireless networks using a second wireless modem of the plurality of wireless modems. For example, wireless device 130 may be communicating on WWAN 106 using wireless modem 126. However, if a drop in data rate or signal strength of WWAN 106 is detected, wireless device 130 may establish a higher data rate or higher signal strength connection for communication on WWAN 102 using wireless modem 122.

In addition, wireless device 130 need not be limited to communicating over a single network at any point in time. For example, wireless device 130 may route a first portion of a wireless communication over one of the available networks, while routing a second portion of the wireless communication over a different one of the available networks. In this way, network resources may be further optimized by directing traffic to different networks simultaneously based on the type, frequency, or amount of traffic. For example, if an Application X generally sends and receives large amounts of data, the user may prefer to direct traffic to and from Application X over WWAN 106. In addition, Application Y may require very little bandwidth and so the user may want to direct traffic to and from Application Y over WWAN 104 to spread out the total bandwidth requirements of wireless device 130. In addition, an application that communicates a small amount of data during a first timeframe and an escalating amount of data during a second timeframe may be transitioned from a first network to a second network as the amount of data communicated exceeds a predetermined threshold in order to reduce the cost of service for the user and/or carrier.

Thus, constantly changing network-wide data may be taken into account in determining appropriate wireless network connection priorities. By analyzing real-time as well as previously collected network parameters reported by a collection of mobile devices and/or from a collection of wireless modems, a real-time macro-level coordination of connections to one or more wireless networks may be realized in order to achieve one or more user-controlled and/or carrier-determined goals.

Examples of such user-controlled and/or carrier-controlled goals may include reducing congestion on a particular wireless network, reducing user and/or carrier costs by selecting the current lowest cost wireless network, matching particular application data with the most appropriate available wireless network, and ensuring highest user QoS regardless of the wireless connection.

Thus, the present application presents a solution providing mobile network management using multiple wireless modems, based on real-time conditions and events of the wireless device and/or on one or more available wireless networks as evaluated against user-controlled and/or carrier-controlled rules utilizing an intelligent rules engine embedded within the wireless device. Accordingly, end users and carriers alike are able to manage network connections utilizing policies based on a pre-defined set of rules in order to achieve a better, seamless user experience at any point in time.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method of wireless communication using a wireless device, said method comprising:
receiving a plurality of parameters relating to a plurality of wireless networks using a plurality of wireless modems each operable for communication according to one of said plurality of wireless networks;
evaluating said plurality of parameters according to one or more connection rules;
establishing, based on said evaluating, a connection to a first wireless network of said plurality of wireless networks using a first wireless modem of said plurality of wireless modems operable for communication according to said first wireless network.

2. The method of claim 1, further comprising:
scanning said plurality of wireless networks using said plurality of wireless modems for a change in said plurality of parameters;
evaluating said change and said plurality of parameters according to said one or more connection rules;
establishing, based on said evaluating of said change and said plurality of parameters, a connection to a second wireless network of said plurality of wireless networks using a second wireless modem of said plurality of wireless modems.

3. The method of claim 1, further comprising:
communicating said plurality of parameters to a display of said wireless device;
receiving, from a user of said wireless device, a selection from said plurality of wireless networks;
switching said connection from said first wireless modem of said plurality of wireless networks based on said selection.

4. The method of claim 1, wherein each of said plurality of wireless networks is associated with a different wireless carrier.

5. The method of claim 1, wherein each of said plurality of wireless moderns is disposed within a respective mobile device of a plurality of mobile devices.

6. The method of claim 1, wherein each of said plurality of wireless modems is disposed within said wireless device.

7. The method of claim 1, wherein said one or more connection rules comprise carrier-controlled rules.

8. The method of claim 1, wherein said one or more connection rules comprise user-controlled rules.

9. The method of claim 1, wherein said plurality of parameters comprise one or more of a data upload rate, a data download rate, a time of day, a day of the year, a location, a cost of communicating over a particular wireless network, a signal strength associated with said particular wireless network, a carrier identification associated with said particular wireless network, and an availability of a particular network service.

10. The method of claim 1, wherein said method is executed by a software connectivity application within said wireless device.

11. A system of wireless communication, said system comprising:
a wireless device having one or more circuits configured to:
receive a plurality of parameters relating to a plurality of wireless networks using a plurality of wireless moderns each operable for communication according to one of said plurality of wireless networks;
evaluate said plurality of parameters according to one or more connection rules;
establish, based on said evaluation, a connection to a first wireless network of said plurality of wireless networks using a first wireless modern of said plurality of wireless modems operable for communication according to said first wireless network.

12. The system of claim 11, wherein said one or more circuits are further configured to:
scan said plurality of wireless networks using said plurality of wireless modems for a change in said plurality of parameters;
evaluate said change and said plurality of parameters according to said one or more connection rules;
establish, based on said evaluation of said change and said plurality of parameters, a connection to a second of said plurality of wireless networks using a second wireless modem of said plurality of wireless moderns.

13. The system of claim 11, wherein said one or more circuits are further configured to:
communicate said plurality of parameters to a display of said wireless device;
receive, from a user of said wireless device, a selection from said plurality of wireless networks;
switch said connection from said first wireless modem of said plurality of wireless networks based on said selection.

14. The system of claim 11, wherein each of said plurality of wireless networks is associated with a different wireless carrier.

15. The system of claim 11, wherein each of said plurality of wireless modems is disposed within a respective mobile device of a plurality of mobile devices.

16. The system of claim 11, wherein each of said plurality of wireless modems is disposed within said wireless device.

17. The system of claim 11, wherein said one or more connection rules comprise carrier-controlled rules.

18. The system of claim 11, wherein said one or more connection rules comprise user-controlled rules.

19. The system of claim 11, wherein said plurality of parameters comprise one or more of a data upload rate, a data download rate, a time of day, a day of the year, a location, a cost of communicating over a particular wireless network, a signal strength associated with said particular wireless network, a carrier identification associated with said particular wireless network, and an availability of a particular network service.

20. The system of claim 11, wherein said one or more circuits are controlled by a software connectivity application within said wireless device.
